(19) United States
(12) Patent Application Publication
(10) Pub. No.: US 2013/0088000 A1
(43) Pub. Date: Apr. 11, 2013

(54) Hitch Cleat

(71) Applicant: Mack Thomas Boyte, Tega Cay, SC (US)

(72) Inventor: Mack Thomas Boyte, Tega Cay, SC (US)

(21) Appl. No.: 13/271,213

(22) Filed: Oct. 11, 2011

(51) Int. Cl. B60D 1/58

(52) U.S. Cl. 280/762

(57) ABSTRACT

The hitch cleat is a mechanism that that joins a hitch mount to a cleat to secure objects for pulling. A cleat by nature is advantageous for tying and untying knots. This concept is beneficial since ropes need to be carefully secured when pulling objects with vehicles.

This invention pertains to vehicles that have a receiver style hitch mounted for towing. This product is designed to accommodate a rope for pulling objects with a vehicle.

The hitch cleat will allow the user to attach a rope to a cleat fastened to a square tube or bar sized to fit the receiver style hitch. The rope is inserted on the cleat by wrapping two to three turns and a half hitch knot. The number of turns depends on the size of the rope. The rope holds securely and is easily freed when the rope is attached in this fashion.

A trailer hitch receiver, that is usually mounted on the rear of a vehicle, but may also be attached on the front, is usually fitted with a trailer ball mount for towing. This hitch cleat would insert in place of the trailer ball mount. The tubing is cross drilled so the pin, which is purchased separated, can be inserted to allow the hitch adapter to attach rope on a cleat to face in any direction.

Presently, it is common to tie a rope to a ball, which is attached to a trailer ball mount, for pulling objects or to secure a rope in a stationary position. Removal of the rope is usually difficult since the tension on the knot increases as the rope becomes taut. The use of the standard ball mount results in time consuming tying and untying and often the outcome is cutting the rope and removing the pieces.

A trailer ball and mount is a safe and appropriate application for its intended use, which is to pull a trailer. The operation of tying a rope to a trailer ball becomes difficult when an individual attempts to use the ball and mount for pulling and securing objects other than a trailer.

### BRIEF DESCRIPTION OF VIEWS OF THE DRAWINGS

There are two views of the invention that describe the parts and how they are made to the specifications necessary to explain the making of the hitch cleat.

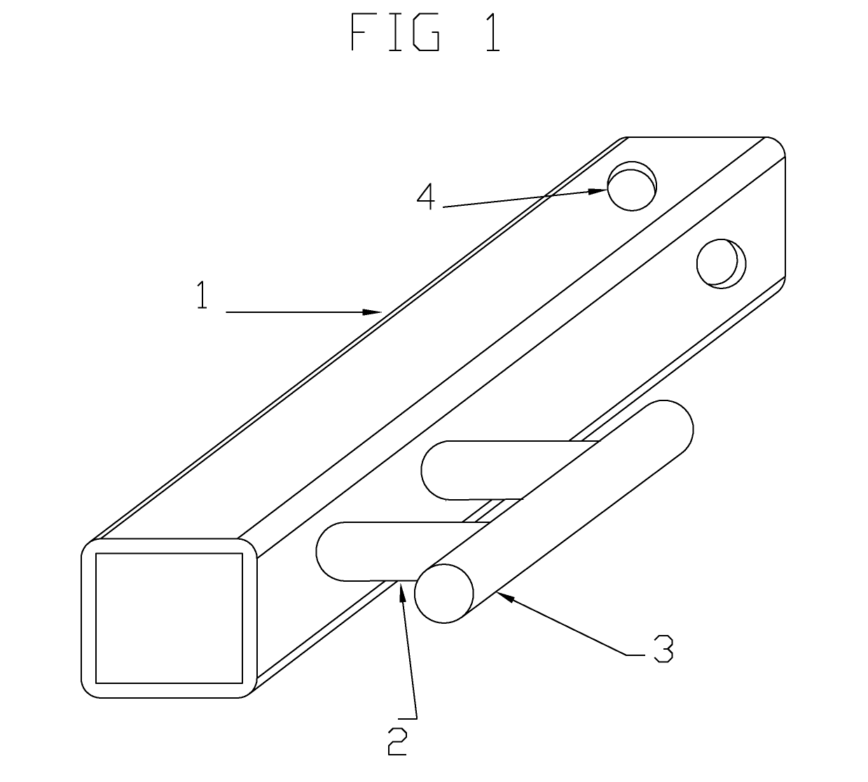

Page 1 FIG. 1

Item 1 is tubing, made of mild steel or any other material of suitable strength.

Item 2 is two solid round bars used to allow space between Item 1 and Item 3. This space is used to wrap the rope several times.

Item 3 is a solid bar longer than Item 2. Item 3 is used to wrap a hitch knot around one end of the bar. It is used to secure the rope from slipping off item 2.

Item 4 is a hole that is used to secure the hitch cleat to the receiver hitch with a pin, that is purchased separately. There are four holes that are drilled 90 degrees from each other that allows the hitch cleat to be attached in any direction.

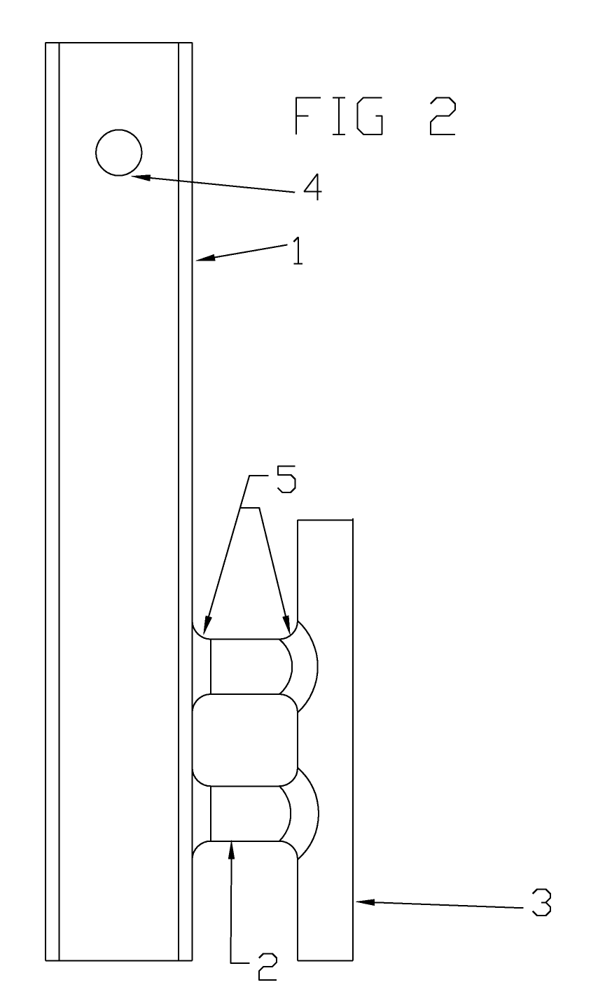

Page 2 FIG. 2

Item 1 through Item 4 are described in the description of page 1.

Item 5 indicates the areas that are welded to secure Item 1 to Items 2 and Items 2 to Item 3.

1. This is claimed to be a piece of tubing or bar with a cleat attached that mounts to an existing trailer hitch for the purpose of tying rope easily and disengaging the rope quickly and with little effort:
This hitch cleat can be developed to fit a class 1, class 2, and class 3 or class 4 trailer hitches.
The hitch cleat can be made of aluminum, steel, stainless steel, titanium, magnesium, brass, bronze, reinforced plastic, or any material of suitable strength.
The hitch cleat could contain one through hole.
The hitch cleat could be bolted instead of welded, or forged or cast as a single piece.
